(19) United States
(12) Patent Application Publication
(10) Pub. No.: US 2025/0298429 A1
(43) Pub. Date: Sep. 25, 2025

(54) Multi-Level Critical Temperature Protection and Workload Efficiency Resilience for a Computer Processor

(71) Applicant: Tenstorrent USA, Inc., Austin, TX (US)

(72) Inventors: Michael Smith, Toronto (CA); Mark Wrogemann, Toronto (CA)

(21) Appl. No.: 19/086,724

(22) Filed: Mar. 21, 2025

Related U.S. Application Data
(60) Provisional application No. 63/569,034, filed on Mar. 22, 2024.

(51) Int. Cl. G06F 1/04

(52) U.S. Cl. CPC G06F 1/04

(57) ABSTRACT

Systems and methods for operating a processing core that is resilient to high-temperature events are disclosed herein. A disclosed system includes a processing unit coupled to a high-speed and a low-speed clock source, along with a clock-independent temperature sensor where the high or low-speed clock signal is provided to the processing core based on a measured temperature from the temperature sensor being over a particular threshold. The system also includes an external triggering circuit and enabling signal that activates after a certain time to cut power to the system after the temperature exceeds the particular threshold.

### CROSS-REFERENCE TO RELATED APPLICATIONS

This application claims the benefit of U.S. Provisional Patent Application No. 63/569,034, filed Mar. 22, 2024, which is incorporated by reference herein in its entirety for all purposes.

### BACKGROUND

Many computing systems that are directed to accelerating artificial intelligence workloads, such as the execution of an artificial neural network (ANN), use the paradigm of distributed parallel computing embodied by, for example, a multicore processor. More generally, these systems can be referred to as a network of computational nodes. In a multicore processor, collaboration among multiple cores is essential for efficiently executing ANNs. The parallel architecture of multicore processors allows for simultaneous processing of different portions of the ANN, significantly speeding up training and inference tasks. During the execution of an ANN, various layers and operations can be divided among the available cores, enabling concurrent computation and reducing overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex neural network models. This collaborative approach optimizes the utilization of available computational resources, enhances parallelism, and contributes to the overall acceleration of AI workloads on multicore processors.

However, despite the advantages of splitting complex computations into component computations in parallel across multiple cores, issues arise if any core fails to perform its component computations such as due to an internal failure of a processor of one of the cores. Recovery techniques may be employed but may have limited effectiveness based on when the failure occurred and when the network became aware of the failure. For example, if a core fails such as due to a failure of a processor of the core, the core may not be able to report the failure to the network since it is the processor that typically generates and sends the notifications and messages to the network. In cores that have high power and high-clock speed, failures may be particularly acute in high temperature conditions, in which a high-speed clock source such as a phase locked loop (“PLL”), internal processor(s), or both are likely to fail in complicated and unpredictable manners that can result in a catastrophic failure where the processor is unable to continue operation to disseminate notifications about the failure, where clock-dependent components in charge of shutting down the processor or saving the state of the processor are unable to function, and where a processor can undergo permanent physical damage such as by melting due to high heat.

### SUMMARY

Systems and methods related to high-temperature resilient computational nodes are disclosed herein. In specific embodiments of the invention, a network of computational nodes includes multiple computational nodes including processing cores. Processing units of the processing cores are typically operated at high power and high-speed to facilitate high-speed parallel processing of component computations of a complex computation distributed over numerous nodes. Based on a variety of causes such as environmental and data center conditions, difficulty of calculations being performed (e.g., in term of usage of processing power, memory, etc. on a node), component wear over time, faulty components, etc., the temperature for a particular core may rise to a level at which the core is likely or probable to have a catastrophic error, such as damage to one or more components of the core (e.g., processing unit(s), PLL, etc.), loss of a computation, or complete shutdown.

Computational node designs often allow adjustments of processor speed using clock frequencies and voltages to gradually reduce the heat load produced by the processor core. However, these adjustment systems may break down if the temperature sensors that are built into the processor core do not accurately reflect the temperature if the processor core malfunctions or if the clock source becomes unstable. A network of computational nodes can include multiple computational nodes including processing cores. Processing units of the processing cores are typically operated at high power and high-speed to facilitate high-speed parallel processing of component computations of a complex computation distributed over numerous nodes. Based on a variety of causes such as environmental and data center conditions, difficulty of calculations being performed (e.g., in term of usage of processing power, memory, etc. on a node), component wear over time, faulty components, etc., the temperature for a particular core may rise to a level at which the core is likely or probable to have a catastrophic error, such as damage to one or more components of the core (e.g., processing unit(s), PLL, etc.), loss of a computation, or complete shutdown.

In some embodiments, temperature sensors can be placed on or near the core in various positions that are clock-independent, that is, they run on separate circuitry that is not dependent on the system clock or the processor core running to accurately measure the temperature. Clock-dependent sensors can respond quickly to temperature fluctuations by adjusting clock frequencies and power levels, but these sensors themselves as well as the clock circuitry can become unreliable if temperatures spike quickly. Clock-independent sensors can react to temperature changes somewhat less quickly but in a more reliable manner to swiftly reduce the clock frequency to a chip to allow it to finish critical calculations, send network messages about temperature conditions, and the like. As used herein clock-independent sensors refer to sensors that not only detect the temperature but also report the temperature on a signal line to external systems without dependency on a clock signal.

In specific embodiments, a processing core in a system that is resilient to high-temperature events is provided. The system can comprise a processing unit, a high-speed clock source coupled to the processing unit to output a high-speed clock signal for the processing unit, a low-speed clock source coupled to the processing unit to supply a low-speed clock signal for the processing unit, a clock-independent temperature sensor, wherein one of the high-speed clock signal or the low-speed clock signal is provided to the processing unit based on a measured temperature from the clock-independent temperature sensor, a circuit path to an external triggering output, wherein the circuit path is clock-independent such that a temperature warning output signal based on the clock-independent temperature sensor is provided to the external triggering output even if the processing unit is not functioning properly, and an external trigger enable signal that activates the circuit path when activated. The external trigger enable signal is activated after passage of a particular time period from the measured temperature exceeding a first threshold, and wherein the external triggering output is used by a power supply to cut power to the processing core.

In specific embodiments, a processing core in a system that is resilient to high-temperature events is provided. The system can comprise a processing unit, an interconnect fabric network connection, a high-speed clock source coupled to the processing unit to output a high-speed clock signal for the processing unit, a low-speed clock source coupled to the processing unit to supply a low-speed clock signal for the processing unit, and a clock-independent temperature sensor. One of the high-speed clock signal or the low-speed clock signal is provided to the processing unit based on a measured temperature from the clock-independent temperature sensor. The system also comprises a circuit path to an external triggering output. The circuit path is clock-independent such that a temperature warning output signal based on the clock-independent temperature sensor is provided to the external triggering output even if the processing unit is not functioning properly. The system also comprises an external trigger enable signal that activates the circuit path when activated. The external trigger enable signal is activated in at least one of the following conditions: (i) after a network notification is sent on the interconnect fabric; and (ii) after a discrete portion of a component calculation is completed by the processing core.

In specific embodiments, a method for operating a processing core that is resilient to high-temperature events is provided. The method comprises supplying a high-speed clock signal from a high-speed clock source to a processing unit, supplying a low-speed clock signal from a low-speed clock source to the processing unit, measuring a temperature of the processing unit using a clock-independent temperature sensor, switching the high-speed clock signal or the low-speed clock signal into the system clock input of the processing unit based on the measured temperature from the clock-independent temperature sensor, and triggering an external triggering output via a circuit path. The circuit path is clock-independent such that a temperature warning output signal based on the clock-independent temperature sensor is provided to the external triggering output even if the processing unit is not functioning properly. The method also comprises activating the circuit path using an external trigger enable signal that is supplied to the circuit path. The external trigger enable signal is supplied after passage of a particular time period from the measured temperature exceeding a first threshold. The external triggering output is used by a power supply to cut power to the processing core.

### BRIEF DESCRIPTION OF THE DRAWINGS

The accompanying drawings illustrate various embodiments of systems, methods, and other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 shows a diagram of a processor core in a system including a clock-dependent temperature sensor for temperature control according to specific embodiments of the invention.

FIG. 2 shows a diagram of a processor core in a system including a clock-independent temperature sensor for temperature control according to specific embodiments of the invention.

FIG. 3 shows a diagram of a processor core in a system including clock-dependent and clock-independent temperature sensors for temperature control according to specific embodiments of the invention.

FIG. 4 shows a process using a clock-dependent temperature sensor for temperature control of a processor core according to specific embodiments of the invention.

FIG. 5 shows a process using clock-dependent and clock-independent temperature sensors for temperature control of a processor core according to specific embodiments of the invention.

FIG. 6 shows a simplified process using clock-independent and optional clock-dependent temperature sensors for temperature control of a processor core according to specific embodiments of the invention.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems related to temperature monitoring and control of computational nodes in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In accordance with the present disclosure, a clock-independent temperature sensor monitors the temperature at one or more critical locations such as at the processing unit(s) of the core. If a temperature threshold is exceeded, an output signal is provided via analog circuitry that is not dependent on the operation of the processing unit(s) or system clock in order to change the system clock to a low-speed clock signal, for example, with a clock speed an order of magnitude or less than a high-speed clock signal. The processing unit is able to operate based on the low-speed clock to perform critical operations, but the rate of temperature increase is reduced dramatically versus operating at the speed of the high-speed clock, preventing runaway conditions in which the processing unit shuts down unexpectedly without being able to take temperature mitigating actions or transmit interim computation results and temperature fault warnings to the network. If the temperature fault is not due to a condition such as damage or defective components, running the processing unit based on the low-speed clock signal will eventually reduce the temperature of the processing unit to the point where the high-speed clock signal may be returned to operation as the system clock, or at least to the point where intermediate results of the complex computation can be saved and/or the workload of the failing processor or core can be transferred to another computational node in the network.

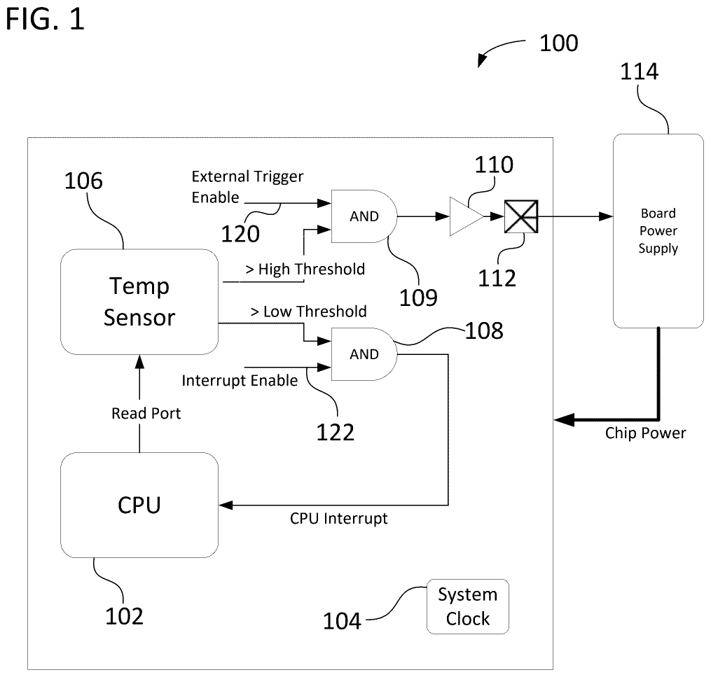

FIG. 1 depicts temperature monitoring circuitry of an exemplary core 100. The core 100 may be a component of a node of a network of computational nodes and may perform component computations of a complex computation that is split among other nodes and their associated cores for parallel processing. FIG. 1 only shows selected components of the exemplary core that are relevant to the temperature monitoring systems and methods depicted and described herein, and it will be understood that a core may include a variety of additional or substituted components. Moreover, while certain logical circuits such as “AND” and “OR” gates, and other circuitry such as multiplexers, inverters, I/O pins, PLLs, and the like are depicted herein, it will be understood that such circuits and their general functionality may be implemented in a variety of manners and the particular circuits and components depicted herein are for illustration and not for limitation of the present disclosure.

In the context of the present disclosure, various portions of the drawings and description may refer to a CPU, processor, or processing unit. It will be understood that such descriptions are for merely for illustration and are not limiting, and that any such description generally includes any processors or combinations thereof that may be used in cores within a network of computations nodes, such as CPUs, graphics processing units (“GPUs”), Tensor Processing Units (“TPUs”), RISC processors, digital signal processors (“DSPs”), quantum processors, and combinations thereof. A processing core may refer to an entire separate unit such as a CPU, but in specific embodiments, it may refer to a portion of a separate unit, for example a single core in a multicore processor.

Returning to FIG. 1, an exemplary core 100 includes a processing unit 102 (e.g., depicted in FIG. 1 as a CPU), a system clock 104, a temperature sensor 106, various logic gates 108, 109, and 110, and an I/O output to an external board power supply 114. The board power supply 114 is a high-power supply that will typically provide power to multiple nodes (and their associated cores) and will include internal logic and appropriate switching and regulators for selectively providing a high-power input to the core 100 capable of powering all components thereof. The power supply can be configured to provide the same voltage or power to various components but can also be configured to adjust power levels individually to these components. As described in the context of FIG. 1, notifications may be provided to the board power supply to indicate high temperature faults that in turn cause the board power supply to reduce or cut off power to the core 100.

The processing unit and temperature sensor operate based on a high-speed clock signal output from the system clock (interconnections not depicted). Under normal conditions in the absence of a high temperature condition, the processing unit operates normally, for example, by performing complex computations, controlling the operations of other circuitry within the core, and communicating with the network (e.g., via a network interface unit (“NIU”) and router).

Although depicted as a single temperature sensor, the temperature sensor may be multiple temperature sensors located at multiple locations on the core or other components of the node (e.g., on a board, other chips, etc.), for example, on multiple components that are susceptible to overheating. Typically, such locations will be on or adjacent to the processing unit, for example, at one or more locations within the processing unit itself, and in some cases on the same die as the processing core. In an embodiment with multiple temperature sensors, the temperatures may be combined in a variety of manners (averages, median, difference, rate of change) etc. to generate one or more temperature values for comparison to thresholds. The temperature sensors of FIG. 1 are “clock-dependent,” in the sense that the sensors are digitally operated and controlled (e.g., as components of the processing unit) or require digital processing to render a useful output (e.g., based on operations performed with the processing unit or other digital circuitry).

In the embodiment of FIG. 1, two thresholds are employed for high temperature fault monitoring, a “low threshold” and a “high threshold.” The low threshold is a high temperature threshold with a lower value than the high threshold, for example, to identify an initial high temperature condition at which the core may continue to operate with the processor possibly taking some remedial actions, such as attempting to limit certain operations, sending notifications of a potential temperature fault to the network, and the like. For example, a notification may cause the network not to route further component computations to the node with the temperature fault, and in some implementations, to duplicate the current complex computation being performed by core 100 on another core. Other remedial actions can be taken as well, such as lowering the clock speed provided to the CPU 102, or somewhat reducing the power or voltage supplied. When the temperature determined by the temperature sensor exceeds the high threshold, this is indicative of a temperature at which permanent damage to the core (e.g., typically to the processing unit) is possible, for example, where permanent damages to transistors, layers, interconnects, and the like of the processing unit may occur if the processing unit continues to operate under the high temperature condition. Accordingly, the high threshold potentially triggers an output signal provided to the board power supply, which in turn may reduce power to the core 100 or shut off power to the core 100.

The low threshold and high threshold outputs are enabled by the CPU asserting appropriate enable signals, such as an external trigger enable 120 or an interrupt enable 122, which in turn allow the digital high threshold and low threshold values to be transmitted through to the processing unit (e.g., as a processor interrupt) or to the board power supply (e.g., as a digital output at a register of the core 100). In typical situations, both enable signals will be asserted to allow the low threshold and high threshold outputs to propagate appropriately. When the processing unit receives the processor interrupt signal corresponding to the low threshold temperature being exceeded, it is able to read the actual temperature value such as via a read port of the temperature sensor. Such readings may influence the actions taken by the processor, for example, based on how close the current temperature reading is to the high threshold and/or the rate of change of the temperature reading.

The system clock that is necessary for the operation of the processor and the temperature sensor may have clock speeds in the GHz range (e.g., 1.3-1.4 GHZ) and may rely upon a clock source such as a PLL (not depicted in FIG. 1). In high temperature conditions, such as those in excess of 80 degrees Celsius, a processor operating at full clock speed may have difficulty mitigating the high temperature condition, even when a signal indicating that the low temperature threshold has been exceeded is timely received. This is largely due to the fact that the processor is still clocked at the full clock speed, resulting in a runaway PLL or runaway processor condition, in which the high temperature and high-speed operation of the processor quickly cascade, for example, prior to the processing unit being able to take mitigating action to protect core 100 from damage or to properly inform the network of the impending failure. Accordingly, not only may damage occur which permanently renders the core 100 unusable, but the entire component computation may be lost without the network being aware of the loss, resulting in the entire complex computation being rendered unusable and wasting precious processing time and power consumption.

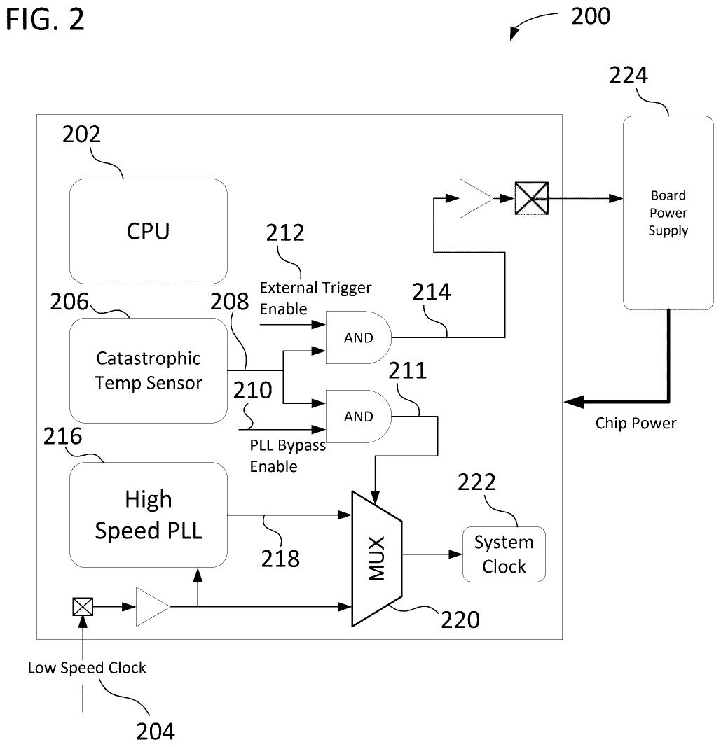

FIG. 2 depicts exemplary temperature monitoring circuitry with clock slow down in accordance with an embodiment of the present disclosure. The core 200 may be a component of a node of a network of computational nodes and may perform component computations of a complex computation that is split among other nodes and their associated cores for parallel processing. FIG. 2 only shows selected components of the exemplary core that are relevant to the temperature monitoring systems and methods depicted and described herein, and it will be understood that a core may include a variety of additional or substituted components.

In the embodiment depicted in FIG. 2, instead of the clock-dependent temperature sensor of FIG. 1, a clock-independent catastrophic temperature sensor 206 is included within node 200. This clock-independent temperature sensor 206 merely needs power to the chip to operate. This clock-independent temperature sensor 206 can be an analog temperature sensor run directly off of one the internal core 200 power signals or rails. The clock-independent temperature sensor 206 may also include internal threshold logic to set one or more thresholds (e.g., one threshold depicted in FIG. 2), such as based on selectable values of comparators (e.g., that hold the comparison value within the comparator). Accordingly, the clock-independent temperature sensor is able to output one or more comparison output values whether or not the system or other internal clocks are functioning.

In the embodiment depicted in FIG. 2, a single clock-independent temperature output signal 208 is depicted as being output to two “AND” logic gates. All logic gates and components within a signal propagation path from the clock-independent temperature sensor are implemented in using analog circuitry, e.g., as clock-independent components operated based on voltage or current comparisons and powered by the core power supply lines/rails. It will be understood that any suitable number of output values may be output from the clock-independent temperature sensor (e.g., based on multiple thresholds implemented such as by comparators) and that multiple clock-independent temperature sensors (e.g., at multiple locations within the core 200) may be implemented in a variety of manners, for example, with each outputting a value based on its own comparison to a unique threshold or based on analog combination of multiple clock-independent temperature signals. Moreover, although two AND logic gates are depicted in FIG. 2, with one enabling a PLL bypass functionality and one enabling an external trigger functionality, it will be understood that such logic may not be included or that additional logic may be provided to allow other clock-independent control actions and notifications. The inputs and power for any logic gate within a signal path propagating from the clock-independent temperature sensor are also clock-independent and will be maintained whatever the clock status or clock speed of the system clock.

Under normal operating conditions, e.g., prior to an output indicating that a threshold for the clock-independent temperature sensor has been exceeded, the PLL bypass enable 210 may be asserted such that the indication of the threshold trigger propagates through the associated AND gate as a PLL bypass signal 211 to a multiplexer 220. The external trigger enable 212 may be initially unasserted, such that the indication of the threshold trigger does not propagate to the board power supply initially. The threshold used by the clock-independent temperature sensor (e.g., via one or more persistent comparators) may be selected based on a variety of predetermined values. For example, the threshold value may be selected based on a temperature at which a performance of the PLL is reduced by more than a first percentage, temperature at which the processing unit commits more than a predetermined percentage of computational errors, or other suitable criteria. In some embodiments, the threshold may be modified (e.g., typically decreased) based on other factors such as time of usage, number of operations performed, prior temperature events, and the like.

Returning to FIG. 2, the multiplexer 220 is controlled by the output of the AND gate, and thus, when the PLL bypass enable is asserted, by the output of the clock-independent temperature sensor 206. The inputs to the multiplexer 220 are different clock signals having different clock speeds. In the embodiment depicted in FIG. 2, a low-speed clock signal 204 (e.g., on a MHz order of magnitude such as 50 MHz) is propagated to cores within the network including core 200, and typically provided to a clock generation circuit such as a PLL 216 which uses the low-speed clock signal 204 as a reference to generate a high-speed clock signal 218 (e.g., typically at least an order of magnitude greater than the low-speed clock signal, such as 1.3-1.4 MHz). In the embodiment of FIG. 2, the low-speed clock signal 204 is also provided as an input to the multiplexer 220, such that the both a high-speed clock signal 218 from the PLL 216 and a low-speed clock signal 204 received via the network are provided as inputs to the multiplexer 220, selectable based on the clock-independent temperature sensor output. Although a low-speed clock signal 204 is depicted as being a network received signal at the core 200, it will be understood that other low-speed clock signals may be provided as inputs to multiplexer, and that more than two different clock speed signal may be provided to the multiplexer. For example, the low-speed clock signal or an intermediate clock signal may be generated internally to the core, or another PLL may output an intermediate speed clock signal (e.g., at clock speed greater than the low-speed clock signal and the high-speed clock signal), or multiple intermediate clock signals may be provided as inputs to the multiplexer, to be potentially selected such as based on multiple clock-independent temperature sensor outputs.

The output of the multiplexer is provided as the system clock 222, e.g., to the processing unit and other clock-dependent circuitry and components of the core 200. Prior to the threshold for the clock-independent temperature sensor being satisfied, the high-speed clock signal is provided as the system clock and the processing unit and other components of the core function normally. Once the threshold is satisfied or exceeded, the multiplexer provides the low-speed clock signal as the system clock. Although the speed of operations of the processing unit and other clock-dependent components is substantially decreased, the low-speed clock signal is adequate to allow the processing unit to continue to operate, including performing component calculations, sending notifications and messages to the network, and the like. The processing unit can be made aware of the high temperature fault based on either detecting the substantially reduced clock speed or receiving a processor interrupt from the clock-independent sensor. Because the clock speed can be reduced by more than an order of magnitude, there is a high likelihood that the temperature of the core 200 will be reduced substantially in this mode of operation. At a minimum, a rate of temperature increase of the processing unit will be decreased, making a runaway or cascading temperature failure much less likely. Once the temperature falls below the threshold (or below a lower threshold based on a desired hysteresis profile), the clock-independent temperature sensor output will change its output which in turn causes the multiplexer to again provide the high-speed clock signal as the system clock.

Operation of the external trigger 214, and the input of the external trigger enable signal 212, may be based on the manner in which the board power supply operates and/or other criteria such as a temperature fault history. For example, the processing unit will still be operating even with the low-speed clock signal provided as the system clock and may assert the external trigger enable signal after passage of a particular time period, after network notifications are sent, after a discrete portion of a component calculation is completed and sent to the network, or other suitable criteria. Specific benefits accrue to those approaches in which the external trigger enable signal is asserted after passage of a particular time period as either measured using an analog circuit (e.g., an RC circuit) or the low speed clock in that the processor may already be in a compromised state such that it would not send network notifications or complete such discrete portions of component computations or be able to assert the external trigger enable signal based on those events. Moreover, if the board power supply 224 is enabled to take different actions in different situations, such as based on passage of time since the temperature fault, the external trigger may be enabled all or most of the time. For example, the board power supply 224 may wait for an initial period of time to reduce power, reduce power in stages over time, and if the temperature fault is not cleared (e.g., as indicated by the output of the clock-independent temperature sensor propagated via the AND gate), eventually shut off power. Though this example shows the external trigger signal 214 and the PLL bypass signals 211 triggered using the same temperature threshold signal 208 for simplicity, these triggers may also be configured to have different temperature thresholds. In some embodiments, the external trigger can be not enabled most of the time, where it can be enabled after an initial period of time, so that if the catastrophic temperature sensor is still reading a temperature over the threshold after an initial time period, the external trigger can be enabled so that the external system such as the board power supply cuts power to the processor core. In specific embodiments, the temperature threshold message can be sent over the network interconnect fabric to components of the system board, other processing cores or other computational nodes, or system controllers that may provide functions such as load-balancing and the like. In some cases, the time period can be overridden by the system, for example, when a particular calculation is finished by the processor core or another network message directs the enable signal to be turned off until a later notification. In this case, the external trigger enable signal may be activated from a signal from other locations in the network after a certain time, or after a particular calculation or set of calculations is complete.

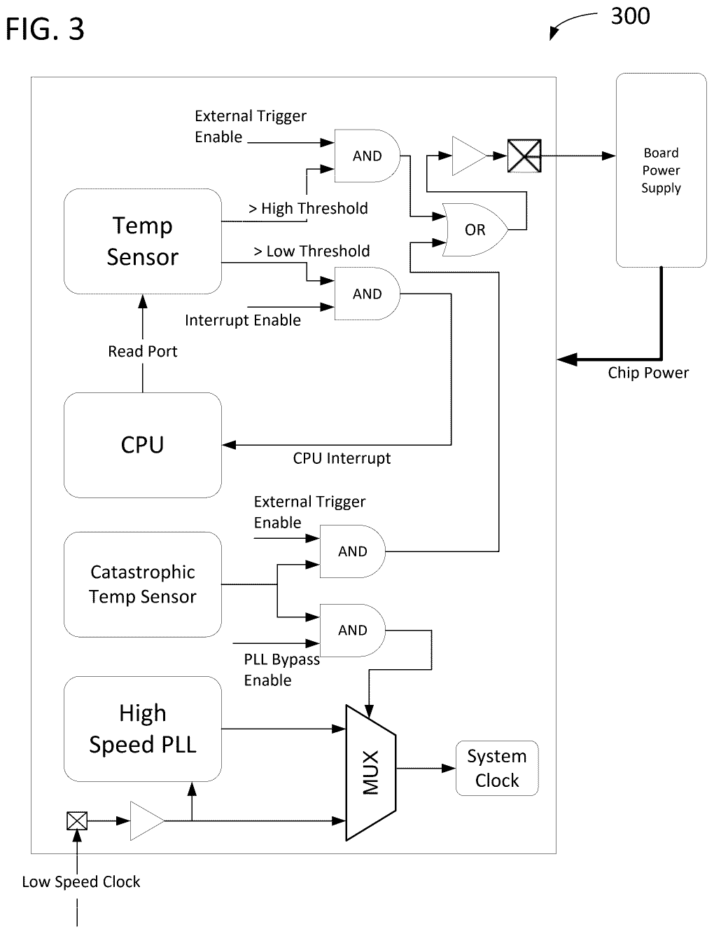

FIG. 3 depicts a system with combined temperature monitoring circuitry and clock slow down. The core 300 may be a component of a node of a network of computational nodes and may perform component computations of a complex computation that is split among other nodes and their associated cores for parallel processing. FIG. 3 only shows selected components of the exemplary core 300 that are relevant to the temperature monitoring systems and methods depicted and described herein, and it will be understood that a core may include a variety of additional or substituted components.

In the embodiment depicted in FIG. 3, both the clock-dependent (e.g., digital) temperature sensing and clock-independent (e.g., analog) temperature sensing are implemented in a combined system. The components in FIG. 3 include all the components of FIGS. 1 and 2 with the addition of an “OR” gate at the external trigger output of each temperature sensing sub-system. It will be understood that the embodiment of FIG. 3 includes all variations and embodiments of each sub-system as described for each of FIG. 1 (clock-dependent temperature sensing) and FIG. 2 (clock-independent temperature sensing with clock slow down). In this manner, multiple different thresholds for multiple different temperatures may be implemented with different mitigation strategies. For example, the low threshold of the clock-dependent temperature sensor sub-system and the high threshold of the clock-dependent temperature sensor sub-system may be lower than the threshold of the clock-independent temperature sensing subsystem. Moreover, thresholds may be modified dynamically (e.g., by the processing unit changing digital thresholds for the low threshold and high threshold, and changing a comparison value (e.g., of a comparator) for the one or more thresholds of the clock-independent temperature sensor). Under normal operating conditions, the clock-dependent temperature sensors may be more tightly integrated with the processor core and give a somewhat more accurate and timely readout of immediate temperature changes. In this case, power or clock adjustments at a smaller level can be sufficient to ameliorate local heating before they reach a catastrophic level. However, in the event where quickly changing temperature conditions make the clock-dependent temperature sensors and/or the system clock PLL inaccurate or even inoperable, the clock-independent sensor and associated circuitry can intervene before system damage occurs.

As an example, an initial mitigation strategy may be based on the low threshold value being exceeded. The processor interrupt signal may be provided to the processing unit (e.g., based on interrupt enable being asserted), and mitigations can be performed by the processing unit while operating at the normal high-speed clock speed provided via the PLL. Alternatively, the processor may choose to reprogram the PLL slightly to reduce the clock frequency. If the temperature further increases to exceed the high threshold of the temperature sensor sub-system, and an output signal can be is provided to the multiplexer (e.g., based on PLL bypass enable being asserted) then the system clock can be switched to the low-speed clock, potentially substantially decreasing the temperature of the core or at least the rate of temperature increase of the core based on a clock speed that is lower (e.g., more than an order of magnitude lower than the high-speed clock signal). If the reduction of the clock speed does not work to reduce the temperature over time, or other triggering actions are completed (e.g., completion of a discrete part of a component calculation and/or successful sending of notifications to the network) the external trigger can be provided to the board power supply, and additional mitigation strategies such as reducing power or shutting off power can be performed. This mitigation strategy can be conducted by temperature-dependent sensing system (e.g., based on External Trigger Enable being asserted). As illustrated, the catastrophic temperature sensor can trigger both actions to take place (e.g., switching the system clock to a low-speed clock and triggering the suppression of the board power supply).

In specific embodiments, the clock-dependent temperature sensor can be more accurate and produce more timely results than the clock-independent temperature sensor. In some examples, the clock-dependent temperature sensor can be built into the die of a processor core, where one or more sensors can be placed around various portions of the core. Changes in temperature can be seen more quickly as the heat is generated right near the sensor itself. The clock-independent temperature sensor could be placed at the die level, could be found in the packaging components, or could be otherwise external to the processor. The temperature measured may be inaccurate because the temperature sensor has less sophisticated trimming circuitry, or may be external to the die such that it does not exactly reflect the die temperature. Moreover, there can be a time lag for heat to transfer through the processor exterior to an outside sensor. Under normal use with an acceptable temperature range, the clock-dependent temperature sensor has some of these advantages; however because it needs the processor to be running near nominal capacity ranges to have an accurate readout, it may not be as reliable as a clock-independent temperature sensor, which can detect changes outside the possible range of the clock-dependent sensor. In a system as depicted in FIG. 3, the advantages of both types of sensors are combined, with the quick response of the temperature-dependent sensor enabling quick changes to counteract the movement of temperature at various points in the system, while the clock-independent temperature sensor can act to prevent catastrophic failure.

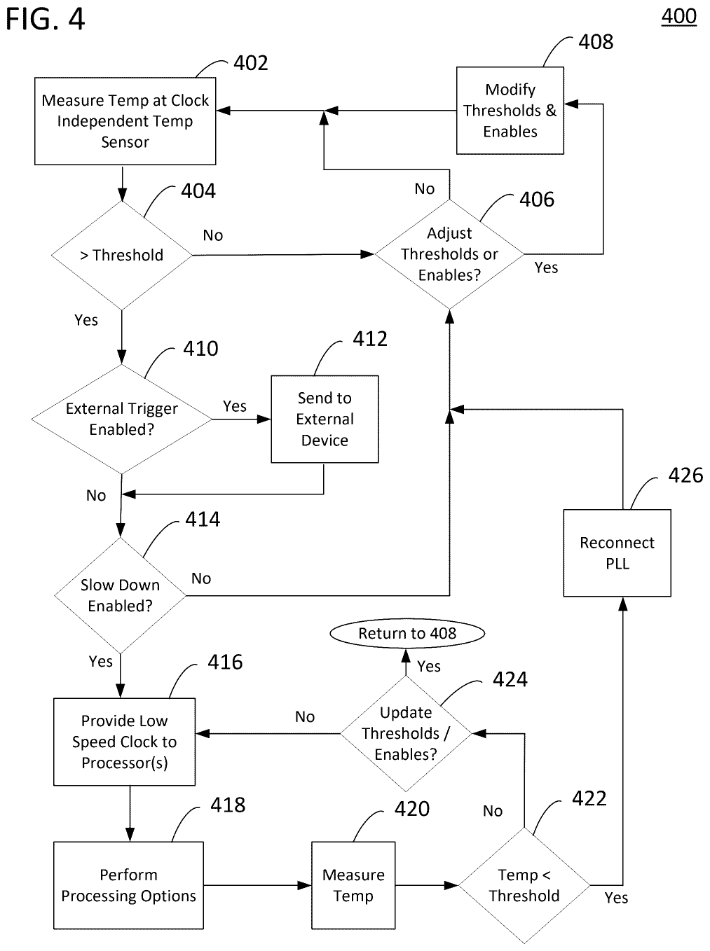

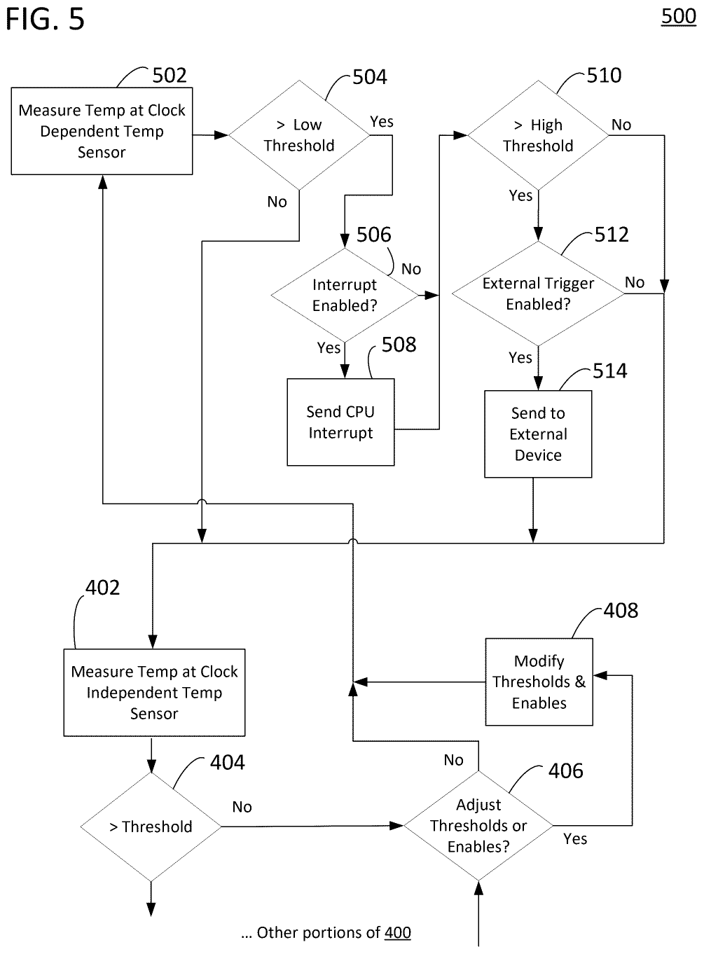

FIG. 4 depicts process 400 including exemplary steps of temperature monitoring with clock slowdown in accordance with an embodiment of the present disclosure. Although particular steps are depicted in a particular order in FIG. 4, it will be understood that the order of certain steps may be modified in accordance with the present disclosure and that steps may be added or removed in certain embodiments. For example, FIG. 4 generally depicts the operation of temperature monitoring based on a clock-independent temperature sensor with clock slow down as depicted and described with respect to FIG. 2. It will be understood that additional steps may be added or interposed, for example, in a combined system such as that depicted and described with respect to FIG. 3; an example will be shown in FIG. 5.

Process 400 begins at step 402, at which a clock-independent temperature sensor measures a temperature at one or more locations of the core or associated with the core. Processing then continues to step 404, at which the measured temperature value is compared to a threshold (e.g., via one or more comparators). If the threshold is not exceeded there is not a temperature fault, and processing continues to step 406.

Step 406 may be encountered via a number of steps in the process described and depicted in FIG. 4 and provides an opportunity to adjust thresholds or enables. For example, when step 406 is encountered via a “No” at step 404 (e.g., indicating threshold not met), thresholds and enables may be adjusted based on factors such as passage of time, processing cycles, or other conditions such as messages from the network (e.g., indicating a likely high temperature event in the data center, etc.). For example, a condition may exist in which the external trigger enable should be asserted immediately, e.g., even prior to any thresholds being exceeded, to employ power supply related mitigation measures. If the thresholds or enables are to be adjusted, processing continues to step 408 where such values are adjusted (e.g., by the processing unit in a persistent manner) and then back to step 402 to continue measuring temperature at the clock-independent temperature sensor. If the thresholds or enables are not to be adjusted, processing continues directly to step 402 to continue temperature measurement.

If the threshold is exceeded, processing continues to step 410, at which it is determined whether the external trigger is enabled. If the external trigger is enabled, the indication of the temperature fault is transmitted to an external device such as the board power supply at step 412, mitigation strategies such as power supply reduction are implemented, and processing then then continues to step 414. If the external trigger is not enabled, processing continues directly to step 414.

At step 414 it is determined whether the slowdown is enabled (e.g., via assertion of the PLL bypass enable signal). In some circumstances, for example, where time critical computations are being performed for only a short time, it may not be desirable to implement the clock slow down even if the measured temperature has exceeded the threshold. If the slowdown is not enabled, processing returns to step 406 to consider whether to adjust thresholds or enables, such as after the completion of said time critical computation. If clock slowdown is enabled, processing continues to step 416.

At step 416, the low (or lower) speed clock is provided as the system clock that in turn is utilized by the processing unit. Although in embodiments the selection of the clock may be between a high-speed clock signal output from a PLL on the core or a network supplied low-speed clock signal, other clock signals such as intermediate clock signals may be provided as described herein. In some cases, the high-speed clock can be generated from a PLL using the lower speed clock signal. Processing then continues to step 418.

At step 418, a low-speed clock signal is provided as the system clock, which reduces the clocking of the processing unit and should reduce the core temperature or at least reduce a rate of increase of the core temperature to allow additional processing to be performed. The processor then may perform operations at the reduced clock speed, providing time to send notifications of the temperature fault to the network, to complete discrete portions of component calculations, and perform other critical operations. While processing is being performed at step 418, the steps of the process of FIG. 4 also continue to step 420.

At step 420, the temperature may be measured again, such as by the clock-independent temperature sensor. In some embodiments, other temperature sensors such as clock-dependent temperature sensors (e.g., as depicted in FIG. 3) may also perform additional temperature measurements. Processing may continue to step 422.

At step 422, it may be determined whether the temperature is less than a threshold, which in some embodiments may be the same as the threshold of step 404 or in other embodiments may be a different threshold (e.g., adjusted at steps 406 and 408 after an initial breach of the threshold, to a lower value than the initial threshold). If the temperature is less than the threshold, processing continues to step 426. If the temperature is not less than the threshold at step 422, processing continues to step 424, at which it is determined whether any threshold or enabled are to be adjusted, for example, to assert the external trigger enable or to adjust temperature thresholds. If any adjustments are to be made, processing continues to step 408, at which the thresholds or enables are updated. If no adjustments are to be made, the loop of low-speed operations and temperature comparison continues at steps 416-422.

If step 426 is reached because the temperature is less than threshold at step 422, the temperature has reached a level at which the high-speed clock signal (e.g., from a PLL via a temperature controlled multiplexer) is reenabled as the system clock, and processing continues to step 406 at which it is determined whether any thresholds or enable are to be adjusted, for example, back to an initial state to enable slow down at a higher temperature.

In specific embodiments, process 400 can be amended with additional steps incorporating features from FIG. 3 into a new process 500, which is depicted in FIG. 5. In this example, the upper portion of process 400 is shown in FIG. 5 beginning with step 402 which proceeds as previously described with the exception that steps 406 and 408 may lead back to step 502 rather than step 402.

Process 500 begins at step 502, at which a clock-dependent temperature sensor measures a temperature at one or more locations of the core or associated with the core. Processing then continues to step 504, at which the measured temperature value is compared to a low threshold (e.g., via one or more comparators). If the low threshold is not exceeded there is not a temperature fault detected here, and processing continues to step 402, where the temperature can be checked again using the clock-independent temperature sensor which acts as a catastrophic temperature sensor. This additional check is necessary as this can still detect temperature problems when the clock-dependent portions have stopped working or are behaving unreliably (e.g., the system clock internal to the core through a PLL has changed behavior based on high temperatures). If the low threshold was exceeded, processing continues to step 506, where it is determined if the CPU interrupt is enabled. If so, an interrupt signal can be sent at step 508 to inform the processor core or the network that processing loads may need to be adjusted or warn other parts of the system that system temperature issues should be monitored more closely.

Processing then continues to step 510, at which the measured temperature value is compared to a high threshold (e.g., via one or more comparators). If the high threshold is not exceeded, the process can continue to step 402. Otherwise, processing continues to step 512, where it is determined if the external trigger for the clock-dependent circuit is enabled. If so, a signal can be sent to an external device that may lower or cut off power to the processor core. In some embodiments, processor frequency can be lowered incrementally or otherwise to attempt to reduce power consumption and heating based on the external trigger. In either case, processing continues with step 402. After the process steps as outlined in process 400, the monitoring loop repeats back to step 502. In this manner, in normal operation, both the clock-dependent and clock-independent temperature sensors can be monitored with various actions taking place at a desired number of temperature thresholds. In some cases, when the clock-independent temperature sensor reading remains higher than its threshold, the monitoring loop can return from steps 406 and 408 directly back to step 402 (equivalent to process 400). This mode can continue for a set time while temperatures remain very high; after the set time or after the clock-independent sensor measures temperatures below its threshold, process 500 as outlined can resume.

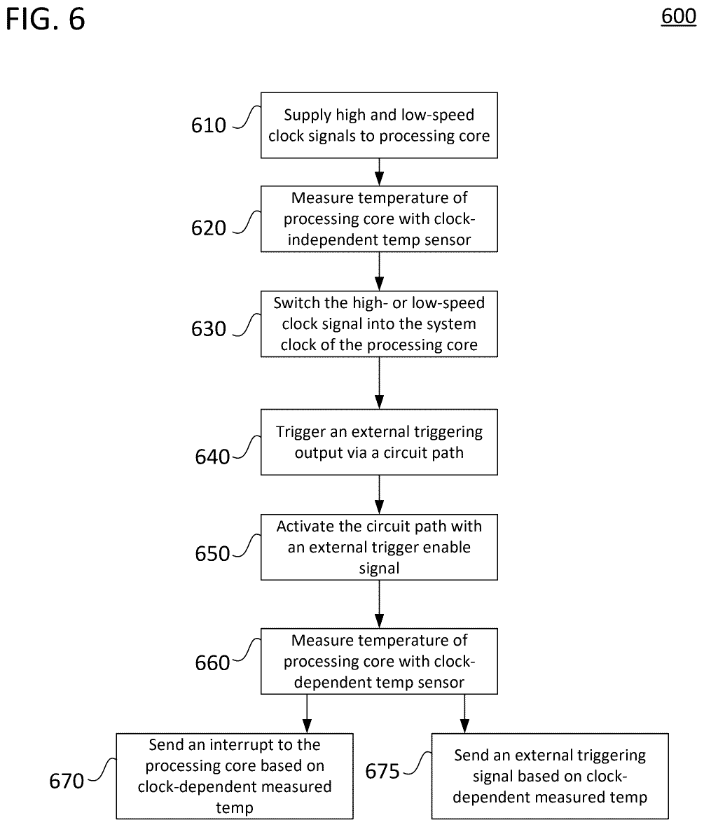

FIG. 6 depicts a process 600 including exemplary steps of temperature monitoring with clock slowdown in accordance with an embodiment of the present disclosure. In step 610, a high-speed clock signal and a low-speed clock signal are provided to a processing core. In step 620, the temperature of the processing core can be measured using a clock-independent temperature sensor. In step 630, the low- or high-speed clock signal can be switched into the processing core as its system clock. The processor core may have already been using one or the other of these signals, and the switching can be based on the temperature measured at the clock-independent temperature sensor in step 620 as compared to a particular threshold temperature. In step 630, based on the measured temperature at the clock-independent sensor, the low-speed or high-speed clock signal can be switched into the processing core as its system clock. In step 640, a circuit path can be triggered with an external triggering output. This will take effect in step 650, if the circuit path is activated with an external trigger enable signal.

The following steps may be optionally used in some embodiments. In step 660, the temperature of the processing core can also be measured using a clock-dependent temperature sensor. Based on the temperature measurement from the clock-dependent temperature sensor, in step 670, an interrupt can be sent to the processing core, or another external triggering signal can be sent to an external circuit path in step 675.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A processing core that is resilient to high temperature events, comprising:
a processing unit;
a high-speed clock source coupled to the processing unit to output a high-speed clock signal for the processing unit; and
a low-speed clock source coupled to the processing unit to supply a low-speed clock signal for the processing unit; and
a clock-independent temperature sensor, wherein one of the high-speed clock signal or the low-speed clock signal is provided to the processing unit based on a measured temperature from the clock-independent temperature sensor;
a circuit path to an external triggering output, wherein the circuit path is clock-independent such that a temperature warning output signal based on the clock-independent temperature sensor is provided to the external triggering output even if the processing unit is not functioning properly; and
an external trigger enable signal that activates the circuit path when activated;
wherein the external trigger enable signal is activated after passage of a particular time period from the measured temperature exceeding a first threshold; and
wherein the external triggering output is used by a power supply to cut power to the processing core.

2. The processing core of claim 1, wherein the high-speed clock source comprises a phase locked loop (“PLL”).

3. The processing core of claim 2, wherein the high-speed clock signal is provided to the processing unit when the measured temperature is less than a first temperature at which a performance of the PLL is reduced by more than a first percentage.

4. The processing core of claim 1, wherein the high-speed clock signal is provided to the processing unit when the measured temperature is less than a first temperature at which the low-speed clock signal is provided to the processing unit.

5. The processing core of claim 4, wherein the first temperature is reduced over time based on a total run time of the processing unit.

6. The processing core of claim 1, wherein the high-speed clock signal is provided to the processing unit when the measured temperature is less than a first temperature at which the processing unit commits more than a predetermined percentage of computational errors.

7. The processing core of claim 1, further comprising a multiplexer, wherein the multiplexer determines which of the high-speed clock signal or the low-speed clock signal is provided to the processing unit based on the measured temperature.

8. The processing core of claim 7, further comprising an enabling gate located between the clock-independent temperature sensor and the multiplexer, wherein in a first state the enabling gate allows the clock-independent temperature sensor to control the multiplexer based on the measured temperature, and wherein in a second state the enabling gate does not allow the clock-independent temperature sensor to control the multiplexer such that the high-speed clock signal is provided to the processing unit without regard to the measured temperature.

9. The processing core of claim 1, wherein a first clock speed of the high-speed clock signal is at least an order of magnitude greater than a second clock speed of the low-speed clock signal.

10. The processing core of claim 1, wherein the processing unit conducts computations using the low-speed clock signal, and wherein the processing unit continues to conduct computations using the low-speed clock signal until a triggering event occurs.

11. The processing core of claim 10, wherein the measured temperature is a first temperature, and wherein the triggering event is that a second temperature determined by the clock-independent temperature sensor is below a threshold value that is less than the first temperature by at least predetermined temperature value.

12. The processing core of claim 1, further comprising:
a clock-dependent temperature sensor, wherein an interrupt signal is provided to the processing core based on a measured temperature from the clock-dependent temperature sensor exceeding a first threshold temperature.

13. The processing core of claim 1, further comprising:
a clock-dependent temperature sensor, wherein the power level or the clock frequency provided to the processing core is lowered based on a measured temperature from the clock-dependent temperature sensor exceeding a second threshold temperature.

14. A processing core, comprising:
a processing unit;
an interconnect fabric network connection;
a high-speed clock source coupled to the processing unit to output a high-speed clock signal for the processing unit; and
a low-speed clock source coupled to the processing unit to supply a low-speed clock signal for the processing unit; and
a clock-independent temperature sensor, wherein one of the high-speed clock signal or the low-speed clock signal is provided to the processing unit based on a measured temperature from the clock-independent temperature sensor;
a circuit path to an external triggering output, wherein the circuit path is clock-independent such that a temperature warning output signal based on the clock-independent temperature sensor is provided to the external triggering output even if the processing unit is not functioning properly; and
an external trigger enable signal that activates the circuit path when activated;
wherein the external trigger enable signal is activated in at least one of the following conditions: (i) after a network notification is sent on the interconnect fabric; and (ii) after a discrete portion of a component calculation is completed by the processing core.

15. The processing core of claim 14, wherein the external trigger enable signal is activated by either: (i) at least one of the following conditions (a) after the network notification is sent on the interconnect fabric, and (b) after the discrete portion of the component calculation is completed by the processing core; or (ii) a particular period of time after the low-speed clock signal is provided to the processing unit.

16. A method for operating a processing core, comprising:
supplying a high-speed clock signal from a high-speed clock source;
supplying a low-speed clock signal from a low-speed clock source;
measuring a temperature of the processing unit using a clock-independent temperature sensor;
switching the high-speed clock signal or the low-speed clock signal into a system clock input of the processing unit based on the measured temperature from the clock-independent temperature sensor;
triggering an external triggering output via a circuit path, wherein the circuit path is clock-independent such that a temperature warning output signal based on the clock-independent temperature sensor is provided to the external triggering output even if the processing unit is not functioning properly; and
activating the circuit path using an external trigger enable signal that is supplied to the circuit path;
wherein the external trigger enable signal is supplied after passage of a particular time period from the measured temperature exceeding a first threshold; and
wherein the external triggering output is used by a power supply to cut power to the processing core.

17. The method of claim 16, wherein the high-speed clock source comprises a phase locked loop (“PLL”).

18. The method of claim 17, wherein the high-speed clock signal is provided to the processing unit when the measured temperature from the clock-independent temperature sensor is less than a first temperature at which a performance of the PLL is reduced by more than a first percentage.

19. The method of claim 16, wherein the high-speed clock signal is supplied to the processing unit when the measured temperature from the clock-independent temperature sensor is less than a first temperature at which the low-speed clock signal is supplied to the processing unit.

20. The method of claim 19, wherein the first temperature is reduced over time based on a total run time of the processing unit.

21. The method of claim 16, wherein the high-speed clock signal is supplied to the processing unit when the measured temperature from the clock-independent temperature sensor is less than a first temperature at which the processing unit commits more than a predetermined percentage of computational errors.

22. The method of claim 16, wherein switching the high-speed clock signal or the low-speed clock signal into the system clock input uses a multiplexer, wherein the multiplexer determines which of the high-speed clock signal or the low-speed clock signal is provided to the processing unit based on the measured temperature from the clock-independent temperature sensor.

23. The method of claim 22, wherein activating the circuit path using an external trigger enable signal uses an enabling gate located between the clock-independent temperature sensor and the multiplexer, wherein in a first state the enabling gate allows the clock-independent temperature sensor to control the multiplexer based on the measured temperature from the clock-independent temperature sensor, and wherein in a second state the enabling gate does not allow the clock-independent temperature sensor to control the multiplexer such that the high-speed clock signal is provided to the processing unit without regard to the measured temperature.

24. The method of claim 16, wherein a first clock speed of the high-speed clock signal is at least an order of magnitude greater than a second clock speed of the low-speed clock signal.

25. The method of claim 16, wherein the processing unit conducts computations using the low-speed clock signal, and wherein the processing unit continues to conduct computations based on the low-speed clock signal until a triggering event occurs.

26. The method of claim 25, wherein the measured temperature from the clock-independent temperature sensor is a first temperature, and wherein the triggering event is that a second temperature determined by the clock-independent temperature sensor is below a threshold value that is less than the first temperature by at least a predetermined temperature value.

27. The method of claim 16, further comprising:
measuring a temperature of the processing unit using a clock-dependent temperature sensor; and
sending an interrupt signal to the processing core based on a measured temperature from the clock-dependent temperature sensor exceeding a first threshold temperature.

28. The method of claim 16, further comprising:
measuring a temperature of the processing unit using a clock-dependent temperature sensor; and
sending an external triggering signal to an external unit that can lower the power level provided to the processing core or the clock frequency provided to the processing core based on a measured temperature from the clock-dependent temperature sensor exceeding a second threshold temperature.
